(19) United States
(12) Patent Application Publication
(10) Pub. No.: US 2026/0212561 A1
(43) Pub. Date: Jul. 23, 2026

(54) EXPLORATORY CREATION OF CHARACTER CAST VISUALS USING GENERATIVE AI

(71) Applicant: AUTODESK, INC., San Francisco, CA (US)

(72) Inventors: Joanne Sau Ling LEONG, Markham (CA); Tovi GROSSMAN, Toronto (CA); Fraser ANDERSON, Newmarket (CA); George William FITZMAURICE, Toronto (CA); David LEDO MAIRA, Toronto (CA)

(21) Appl. No.: 19/370,550

(22) Filed: Oct. 27, 2025

Related U.S. Application Data
(60) Provisional application No. 63/748,927, filed on Jan. 23, 2025.

(51) Int. Cl. G06T 11/60; A63F 13/58

(52) U.S. Cl. CPC G06T 11/60; A63F 13/58; G06T 2200/24; G06T 2210/12

(57) ABSTRACT

One embodiment sets forth a computer-implemented method for generating images. The method can include generating, via a generative artificial intelligence (AI) model, a first set of image variants of a first fictional character based at least on one of a sketch of the first fictional character or a textual description of the first fictional character; associating the first set of image variants with a first logical group based on a first group theme and a first group prompt; generating a first character card comprising the first set of image variants associated with the first logical group; and displaying, via a user interface, the first character card to enable selection of at least one of the first set of image variants based on at least the first group theme.

### CROSS-REFERENCE TO RELATED APPLICATIONS

The present application claims the benefit of U.S. Provisional Application titled, “TECHNIQUES FOR IMPLEMENTING EXPLORATORY CREATION OF CHARACTER CAST VISUALS USING GENERATIVE AI”, filed on Jan. 23, 2025, and having Ser. No. 63/748,927. The subject matter of this related application is hereby incorporated herein by reference.

### BACKGROUND

### Field of the Various Embodiments

Embodiments of the present disclosure relate generally to creating images of fictional characters, and more specifically to the exploratory creation of character cast visuals using generative artificial intelligence (AI).

### Description of the Related Art

Computer-based systems are widely used in the production of digital imagery for visual content such as character art, animation, and interactive media. Digital imagery is commonly created through the use of computing platforms equipped with graphics software and rendering hardware that enable the generation, manipulation, and storage of visual assets in electronic form.

In conventional practice, digital artists employ multiple independent software applications to sketch, color, render, and composite visual content. Each application operates as a separate processing environment for creating intermediate image files that require repeated import, export, and format conversion. Revisions to a design often trigger additional rendering cycles and data exchanges among storage devices or networked systems used in collaborative production settings.

One drawback of the foregoing approach is that the foregoing approach performs repeated rendering and data transfer operations across uncoordinated software environments, which increases processing latency and memory bandwidth usage. Another drawback of the foregoing approach is that the foregoing approach generates redundant intermediate data during design revisions, which increases file size, I/O transactions, and storage requirements. A further drawback of the foregoing approach is that the foregoing approach lacks a unified computational framework for correlating related design inputs, which limits scalability and causes inefficient reuse of prior computational results.

As the foregoing illustrates, what is needed in the art are more effective techniques for generating and refining digital imagery using computer-based systems.

### SUMMARY

One embodiment sets forth a computer-implemented method for generating images that includes generating, via a generative artificial intelligence (AI) model, a first set of image variants of a first fictional character based at least on one of a sketch of the first fictional character or a textual description of the first fictional character; associating the first set of image variants with a first logical group based on a first group theme and a first group prompt; generating a first character card comprising the first set of image variants associated with the first logical group; and displaying, via a user interface, the first character card to enable selection of at least one of the first set of image variants based on at least the first group theme.

Other embodiments of the present disclosure include, without limitation, one or more computer-readable media including instructions for performing one or more aspects of the disclosed techniques as well as a computing device for performing one or more aspects of the disclosed techniques.

One technical advantage of the disclosed techniques over the prior art is that the disclosed techniques reduce redundant rendering and data transfer operations, which decreases processing latency and overall memory bandwidth consumption. In addition to reducing latency, the disclosed techniques minimize generation of intermediate files and associated format conversions, thereby lowering I/O overhead and storage utilization during design revisions. The disclosed techniques also improve computational efficiency by coordinating related design inputs within a unified processing framework, which enables reuse of prior computational results across multiple image-generation cycles. Further, network efficiency is improved during collaborative workflows through a reduction in the volume of transmitted image data associated with iterative refinement cycles. Collectively, the disclosed techniques provide a scalable computational environment that enables consistent management of related image variants across diverse design contexts while maintaining efficient use of available processing and storage resources.

These technical advantages provide one or more technological advancements over prior art approaches.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

So that the manner in which the above recited features of the various embodiments can be understood in detail, a more particular description of the inventive concepts, briefly summarized above, may be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 illustrates an image generation system according to various embodiments.

FIG. 2 illustrates a first example operational configuration for generating a character image according to various embodiments.

FIG. 3 illustrates a second example operational configuration for generating a character image according to various embodiments.

FIG. 4 illustrates a third example operational configuration for generating a character image according to various embodiments.

FIG. 5 illustrates an example operational configuration for generating a staging image according to various embodiments.

FIG. 6 illustrates another example operational configuration for generating a staging image according to various embodiments.

FIG. 7 illustrates a first example group of rendered images corresponding to FIG. 6.

FIG. 8 illustrates a second example group of rendered images corresponding to FIG. 6.

FIG. 9 illustrates a generated staging image corresponding to FIG. 6.

FIG. 10 illustrates a fourth example operational configuration for generating a character image according to various embodiments.

FIG. 11 illustrates a fifth example operational configuration for generating a character image according to various embodiments.

FIG. 12 illustrates a history associated with generating of a character image.

FIG. 13 shows an example flowchart of a method for generating a character card according to various embodiments.

FIG. 14 is a detailed illustration of a computing device that can implement the functionalities of an image generation platform according to various embodiments.

### DETAILED DESCRIPTION

In the following description, numerous specific details are set forth to provide a more thorough understanding of the various embodiments. However, it will be apparent to one skilled in the art that the inventive concepts may be practiced without one or more of these specific details.

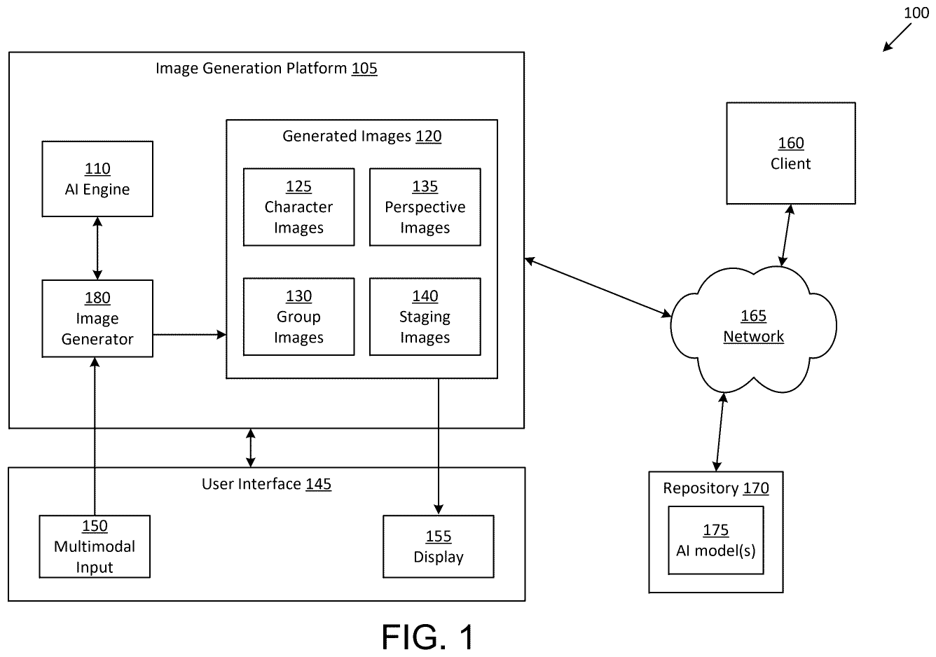

FIG. 1 illustrates a functional representation of an example image generation system 100 according to various embodiments. The image generation system 100 includes a user interface 145 communicatively coupled to an image generation platform 105. The image generation platform 105 is communicatively coupled via a network 165 to various devices, such as a client 160 and a repository 170. The repository 170 can be a client computer, a server, a cloud storage element, or a memory bank, and can implement one or more types of AI model(s) 175. The network 165 can be represent various networks, such as the Internet, an intranet, a corporate network, a wide area network (WAN), and/or a local area network (LAN).

The image generation platform 105 can be implemented on any of various types of computing platforms, such as a server, a client computer, a cloud computer, and/or a networked set of computers. The image generation platform 105 includes an image generator 180 and an AI engine 110 configured to communicate with each other and to generate various types of images according to various embodiments. In the illustrated example, generated images 120 generated by the AI engine 110 include character images 125, perspective images 135, group images 130, and staging images 140. The various images are generated based on multimodal input 150 provided to the image generation platform 105 via the user interface 145. A display 155, that can be included in the user interface 145, can be used to display any one or more of the generated images 120. The displayed images can be evaluated by a user of the user interface 145 (such as a game developer) and used for various purposes, such as modifying one or more of the generated images, generating additional images, exploring new characters, and/or generating staging cards representing multiple characters arranged to provide a visual narrative of interaction among various characters in a cast of characters.

In an example implementation, the AI engine 110 is configured to execute a regenerative AI model. The regenerative AI model can be stored in a memory (not shown) of the image generation platform 105 or can be fetched from the repository 170 via the network 165. In another example implementation, the AI engine 110 can be an artificial intelligence/machine language (AI/ML) engine. The AI/ML engine can be based on a generative AI model, a regenerative AI model, a deep learning model, and/or a linear regression block. The AI/ML engine typically incorporates various types of algorithms and techniques designed to replicate human intelligence. In some implementations, the AI/ML engine performs machine language operations based on information provided in the form of training data. The training data may be generated based on historic operations performed by the AI/ML engine.

The multimodal input 150 can be provided to the image generation platform 105 by using various kinds of hardware, such as a keyboard, a mouse, a joystick, a microphone, a scanner, a camera, a touchpad, a trackpad, a sketchpad, a drawing tablet, and/or a paper tablet. In an example implementation, the multimodal input 150 is provided to the image generation platform 105 in one or more of various unstructured forms, such as a hand-drawn sketch, a piece of text, and/or a reference image. In an example scenario, the hand-drawn sketch, which can be generated using a drawing tablet, can be a line drawing that provides details to enable the AI engine 110 to generate an image of an imaginary character with a desired body structure, proportions, pose, colored hair, clothing, and accessories. In another example scenario, the multimodal input 150 can be provided to the image generation platform 105 in the form of text, such as, for example: “female warrior with blue mechatronic armor, 3d illustration, video game character concept art, white background.” In another example scenario, the multimodal input 150 can be provided to the image generation platform 105 in the form of a reference image shown in a comic book, a magazine, or a photograph.

Character images 125 can be images of various characters based on an overall theme, such as a video game that includes villains and heroes. In an example scenario, character images 125 can include a first character image generated by the image generator 180 in response to a first text-based multi-modal input 150: “a female wearing a red robot armor, blaster gun in one hand, red robotic helmet, brown hair, big eyes.” Character images 125 can further include a second character image generated by the image generator 180 in response to a second text-based multi-modal input 150 that cites: “Evil robot wearing a blue mechatronic outfit.”

Perspective images 135 can be used to visualize a character from different perspectives. Evaluation of perspective images 135 can enable a developer to ensure consistency in the appearance of a character (e.g., height, features, colors, accessories, etc.) in various scenes of a video game, for example. In an example scenario, the perspective images 135 can show the first character image (female wearing red robot armor) as viewed from a number of different angles.

Group images 130 can include various combinations of characters that share one or more visual traits in common. Various characters typically have various relationships and interactions with each other based on a theme (for example, belonging to different clans in a video game). For example, a set of characters may belong to a specific group based on sharing a particular visual trait in common (for example, all elves having pointy ears). Accordingly, various combinations of characters can be categorized into different groups. A group-level text prompt can be assigned to all characters within such a group. An example group-level text prompt entitled “with blue mechatronic armor, 3D illustration, video game character concept art, white background” can be used to select all characters of a specific group of images among the group images 130.

Staging images 140 can include various combinations of characters that interact with each other in an application (in a video game, for example). The user interface 145 can be used to select one or more of the staging images 140 to visualize a set of characters in various scenarios. For example, one of the staging images can be displayed upon the display 155 to visualize an underwater battle scene between the female wearing the red robot armor and the evil robot wearing the blue mechatronic outfit. Another staging image can be displayed upon the display 155 to visualize a battle scene between the female wearing the red robot armor and the evil robot on an alien planet.

Generated images 120 thus facilitate the development of various applications such as video games and comic strips by enabling the design of multiple character images and defining various types of relationships and constraints among characters based on logical groupings.

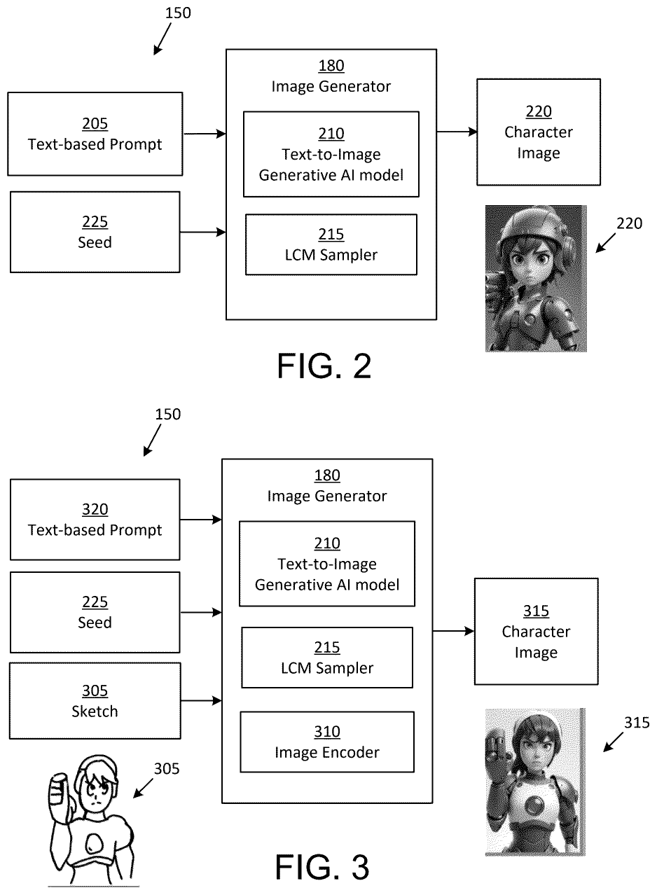

FIG. 2 illustrates a first example operational configuration for generating a character image 220 according to various embodiments. In this example operational configuration, the multimodal input 150 includes a text-based prompt 205 and a seed 225. The character image 220, which is generated by the image generator 180 in response to the multimodal input 150, can be one of the character images 125 described above.

In an example implementation, the text-based prompt 205 includes a group-level text prompt and an image text prompt that is provided inside a character card that is displayable on the display 155 of the user interface 145. The character card can be operated upon by a user for providing a description of the character image 220 and subsequently used for various purposes such as generating a staging image. Accordingly, the user can add new text, edit existing text, or delete existing text associated with the text-based prompt 205. In an example scenario, the text-based prompt 205 can describe a theme or a concept, such as, for example: “3D illustration, video game concept art, highly detailed.” In some cases, the text-based prompt 205 can be a positive prompt that indicates various features to be included in the character image 220. In some cases, the text-based prompt 205 can be a negative prompt that indicates one or more features that are to be expressly precluded in the character image 220 (such as, for example, nudity or vulgarity). In some other cases, the text-based prompt can be a combination of a positive prompt and a negative prompt.

An example text-based prompt 205 for generating a character image can read: “an adult female wearing a (red robot armor and red helmet) with white core blue orb, cannon extending from arm, red robotic helmet, brown hair, big eyes.” The text-based prompt 205 can further include a name of the character shown by the character image 220, and various characteristics associated with the character (color, shape, physical features, etc.).

The image generator 180 includes a text-to-image generative AI model 210 executed by the AI engine 110, that evaluates and responds to the text-based prompt 205. In an example implementation, the shown text-to-image generative AI model 210 is a stable diffusion model that generates high-resolution, high-quality images by using a two-stage process involving a base model for composition and a refiner model for adding fine details. The seed 225 can be a 15-digit number that determines noise characterization used by the text-to-image generative AI model 210 for generating the character image 220. Using the same 15-digit seed number during each subsequent image generation operation ensures the reproducibility of the character image 220. In another implementation, a universal lightweight adapter can be used along with the stable diffusion model to accelerate image generation by optimizing a number of steps used to generate the image. The image generator 180 further includes a latent consistency model (LCM) sampler 215, which is a distilled version of the stable diffusion model.

FIG. 3 illustrates a second example operational configuration for generating a character image 315 according to various embodiments. In such an example operational configuration, the multimodal input 150 includes a text-based prompt 320, the seed 225, and further includes a sketch 125. The text-based prompt 320 in such an example can describe a different character than the one described above with reference to the text-based prompt 205. In an example implementation, the text-based prompt 305 can be provided as a character card that is displayable on the display 155 of the user interface 145 to enable a user to edit the contents of the character card. For example, a user can add new text, edit existing text, or delete existing text. In various cases, the text-based prompt can be a positive prompt, a negative prompt, or a combination of a positive prompt and a negative prompt.

Sketch 305 can be, for example, a line drawing that can be utilized by the image generator 180 in combination with the text-based prompt 320 for generating the character image 315. The image generator 180 in this case includes the text-to-image generative AI model 210, the LCM sampler 215, and an image encoder 310. The image encoder 310 encodes the sketch 305 and provides the encoded data to the text-to-image generative AI model 210. The sketch 305 provides information such as shape, sizing, proportions of body parts, orientation, appearance, and placement of accessories (white core blue orb, etc.) of the desired character image 315 that is generated by the image generator 180.

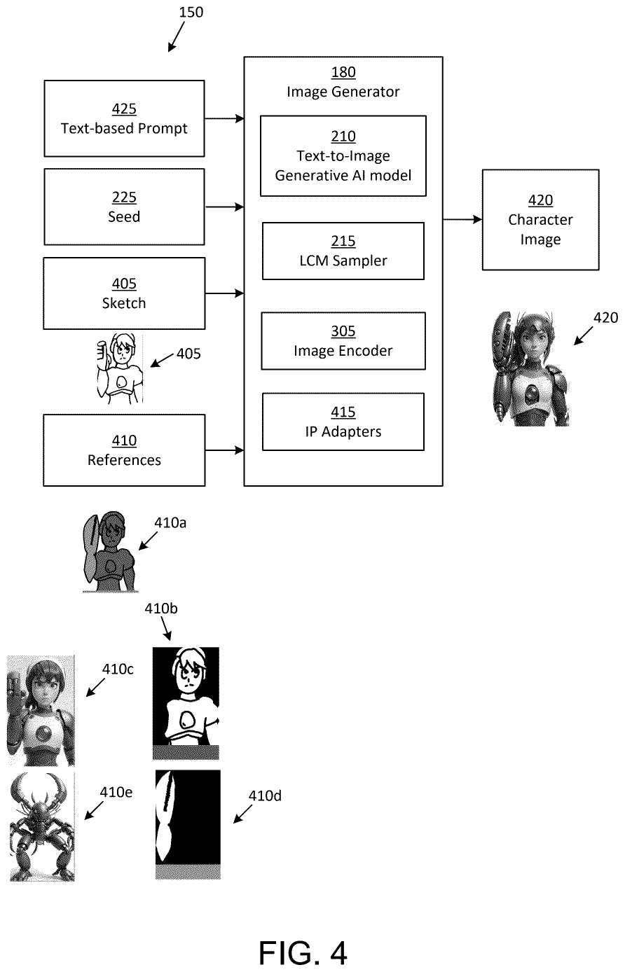

FIG. 4 illustrates a third example operational configuration for generating a hybrid character image 420 according to various embodiments. In this example operational configuration, the multimodal input 150 includes a text-based prompt 425, the seed 225, a sketch 405, and one or more references 410. The text-based prompt 425 in this example can describe the hybrid character image 420. Sketch 405 can be, for example, a line drawing that the image generator 180 can use in combination with the text-based prompt 425 and the one or more references 410 for generating the hybrid character image 420. In the illustrated example, the references 410 include a first reference image 410c and a second reference image 410e. In other implementations, references 410 can include more than two reference images.

The two reference images enable the image generator 180 to generate the hybrid character image 420 that is a hybrid version of a body portion 410b of the first image 410c and a claw portion 410d of the second image 410e. The body portion 410b of the first image 410c can be defined by a first color (red, for example). The claw portion 410d of the second image 410e can be defined by use of a second color (green, for example). A composite sketch 410a, which is a combination of the body portion 410b (in red) and the claw portion 410d (in green), provides a color-coded indication to the image generator 180 of a desired configuration of the hybrid character image 420.

The image generator 180, in this case, includes the text-to-image generative AI model 210, the LCM sampler 215, the image encoder 305, and further includes Image Prompt (IP) adapters 415. The image encoder 305 encodes the sketch 405, which provides the information as described above with reference to sketch 405. A pair of IP adapters 415 enable a body portion 410b (in red) of the first image 410c and the claw portion 410d (in green) of the second image 410e to be used as input to the LCM sampler 215. The LCM sampler 215 operates in cooperation with the text-to-image generative AI model 210 and the image encoder 305 to generate the hybrid character image 420.

A user can modify one or more of the text-based prompt 425, the sketch 405, and/or the references 410 to rapidly generate multiple versions of the hybrid character image 420, either due to dissatisfaction with one or more of the generated versions or to generate image variants of the hybrid character image 420.

As can be understood from the description above, the image generator 180 generates the hybrid character image 420 based on concurrently operating upon the text-based prompt 425, the sketch 405, and the references 410. Such concurrent operation provides a technical advantage over a conventional process that may involve one or more sequential operations performed by a conventional computer for generating a desired image. The conventional computer may, for example, edit a first image (such as the first image 410c) to delete an arm portion, followed by editing a second image (such as the second image 410e) to copy a claw portion, followed by generating a hybrid image of the claw portion of the second image combined with the armless body portion of the first image. The sequential operation not only takes longer to generate a resultant image but may also involve increased processor usage due to generating the multiple edited images and more memory storage associated with storing items such as the armless body portion of the first image, the claw portion of the second image, and the hybrid image.

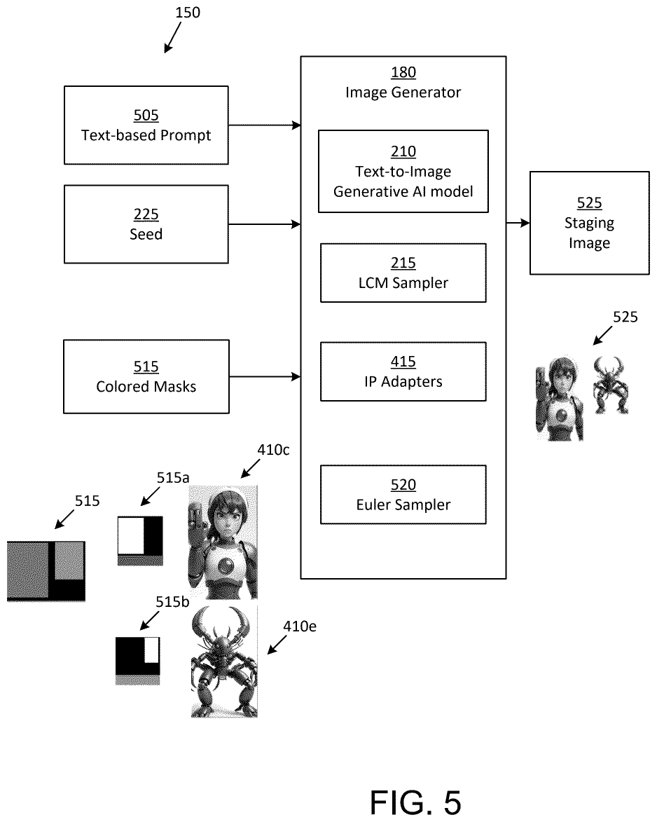

FIG. 5 illustrates an example operational configuration for generating a staging image 525 according to various embodiments. In such an example operational configuration, the multimodal input 150 includes a text-based prompt 505, the seed 225, and a colored mask 515. The text-based prompt 505 in such an example can describe multiple characters that may be included in the staging image 525 generated by the image generator 180. Unlike the hybrid character image 420 described above, in some embodiments, the multiple characters retain individual shapes in their entirety, and are included in the staging image 525 at desired locations relative to each other.

In such a case, the image generator 180 includes the text-to-image generative AI model 210, the LCM sampler 215, IP adapters 415, and a Euler sampler 520. The text-to-image generative AI model 210 generates the staging image 525 based on a combination of the text-based prompt 505, the seed 510, and the colored mask 515.

In such an example implementation, the colored mask 515 includes two bounding boxes having two distinct colors. In other implementations, the colored mask 515 can include more than two bounding boxes. More particularly, the colored mask 515 includes a red bounding box 515a and a green bounding box 515b in correspondence with two characters that are included in the staging image 525. Red bounding box 515a indicates a placement location of the first image 410c in the staging image 525, and the green bounding box 515b indicates a placement location of the second image 410e in the staging image 525. In such an example implementation, each of the red bounding box 515a and the green bounding box 515b is indicated as a rectangle. In other implementations, two or more bounding boxes can be indicated using other shapes and sizes. Each of the various bounding boxes can be specified by a user through various input devices (pen, paint brush, sketch pad, etc.) of the user interface 145.

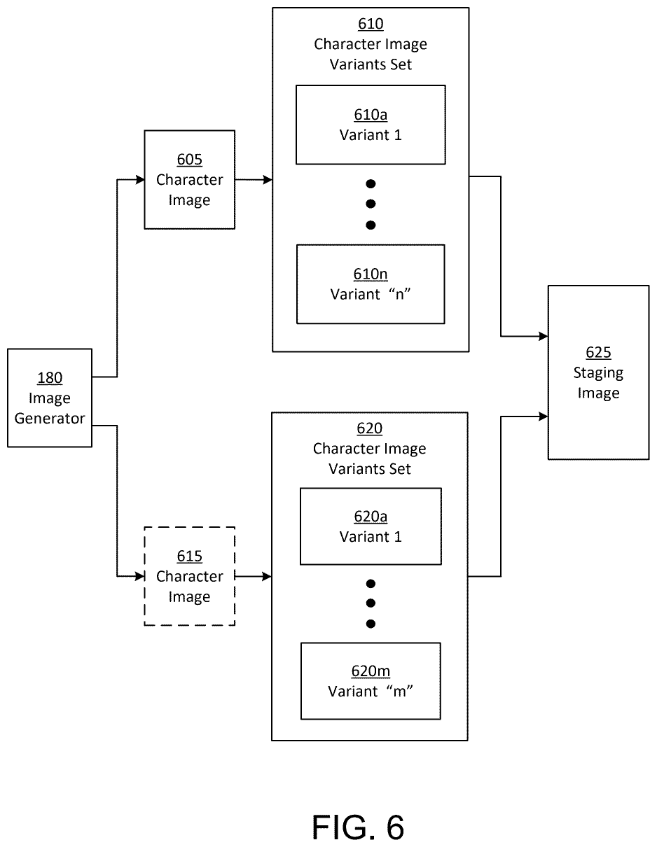

FIG. 6 illustrates a second example operational configuration for generating a staging image 625 according to various embodiments. Under such a configuration, the image generator 180 generates a first character image 605 and a first set 610 of “n” character image variants of the first character image 605. The first character image 605 can be any of the various character images described above, such as the character image 220, the character image 315, the character image 220, or the hybrid character image 420.

The “n” character image variants can be based on varying one or more characteristics of the first character image 605. Examples include a color of hair, a shape of a weapon, an outfit, a role (hero, villain, etc.), a size of one or more body parts, and a number of body parts (multiple arms, legs, etc.). The “n” character image variants can also be based on other factors such as “n” different perspective views of the character image 605, a group theme, or a group prompt.

In an example implementation, the first set 610 of “n” character image variants can be assigned to a first logical group having a group theme titled “hero characters” and a group prompt titled “heroes.” The first logical group can be included in a first character card that is displayed on the display 155 of the user interface 145. The first character card can include various types of information, such as a group character name, individual character names, a group theme, a group prompt, a seed, a text prompt, an image text prompt, and historical image generation information.

The image generator 180 may also generate a second character image 615 and a second set 620 of “m” character image variants of the second character image 615. In one case, “m” can be equal to “n.” In another case, “m” can be greater than or less than “n.” Generation of the character image 615 is optional and can be omitted in some implementations. In one implementation, the “m” character image variants are based on one or more characteristics of the second character image 615. In another implementation, the “m” character image variants are based on a shared characteristic, such as color, number of limbs, or a role (hero, villain, etc.). The “m” character image variants can also be based on “m” different perspective views of the character image 615, a group theme, or a group prompt. In an example implementation, the “m” character image variants may have a group theme titled “villain characters” and a group prompt titled “villains.” The second logical group can be included in a second character card.

In one implementation, the first set 610 of “n” character image variants and the second set 620 of “m” character image variants can be individually or collectively displayed on the display 155 of the user interface 145 to enable a user of the user interface 145 to select two or more image variants among the “m” character image variants. In another implementation, the first character card and the second character card can be individually or collectively displayed on the display 155 of the user interface 145 to enable a user of the user interface 145 to select two or more image variants in one or both logical groups.

The two or more selected image variants are then combined by the image generator 180 for generating the staging image 625. In an example implementation, the staging image 625 is generated based on the use of one or more masks (as described above with respect to FIG. 5) that define a location for each of the multiple image variants.

The user can select various character image variants for inclusion in the staging image 625, based on various criteria. In one case, the character image variants can be selected by a user based on various types of stages (ocean, forest, alien landscape, space, time period, etc.) to allow the user to evaluate how well the characters fit with respect to one another and/or with respect to the environment and/or time period. In an example scenario, a user can configure the character image variants of one or both logical groups by using a text-based prompt that includes words such as, for example, “fish”, “trout”, “shark”, “jellyfish”, “piranha fish”, and “lantern fish”. After evaluating the resulting generated images, the user may be inspired to generate additional image variants or modify the generated image variants by including words in the text prompt such as “lobster”, “crab with giant mechanistic claw”, “shrimp”, and “squid.” When satisfied with the image variants set, the user may evaluate the staging image 625 to finalize various combinations of characters and/or various environments based on additional text prompts such as ocean, forest, alien landscape, etc.

The various operations described above with reference to generating various characters and evaluating various staging scenarios can be performed very rapidly in comparison to conventional procedures that include various constraints (multiple operational steps, more computer usage, more memory storage use, etc.).

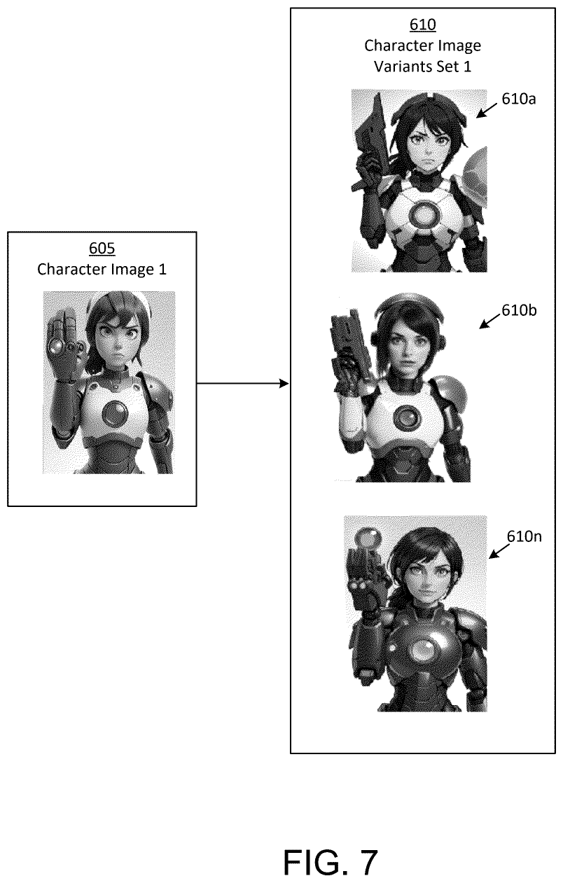

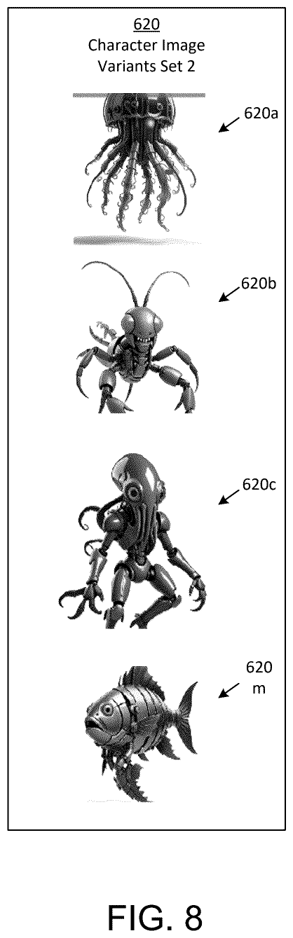

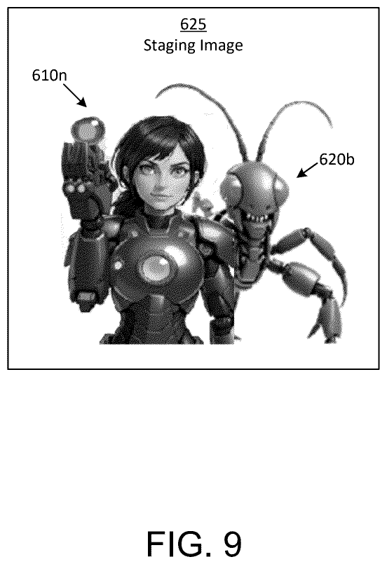

FIG. 7 shows a first set of example rendered images corresponding to character image 605 and the first set 610 of “n” character image variants illustrated in FIG. 6. FIG. 8 shows a second set of example rendered character images corresponding to the second set 620 of “m” character image variants illustrated in FIG. 6. FIG. 9 shows an example rendered image corresponding to the staging image 625 illustrated in FIG. 6. In such an example, the staging image 625 includes a character image 610n selected from the first set 610 of “n” character image variants shown in FIG. 7, staged along with a character image 620b selected from the second set 620 of “m” character image variants shown in FIG. 8.

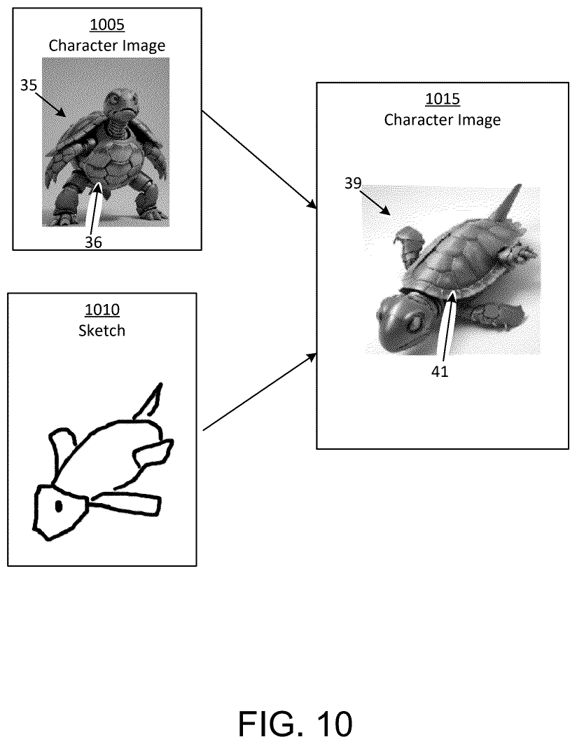

FIG. 10 illustrates a fourth example operational configuration for generating a character image 1015 according to various embodiments. In such an example, the image generator 180 is configured to generate a character image 1015 based on selectively including a portion of a character image 1005 into the character image 1015 that is generated based on a hand-drawn sketch 1010. Generating a character image responsive to a sketched input is described above with reference to FIG. 3 and other figures. Selectively including a portion of an input image into a generated character image is described above with reference to FIGS. 4 and 5. In the illustrated example, the character image 1015 is a cartoon turtle 39 that includes a shell 41 that resembles a shell 36 of a turtle 35 that is the character image 1005. Shell 41 generally resembles shell 36 in color and shape.

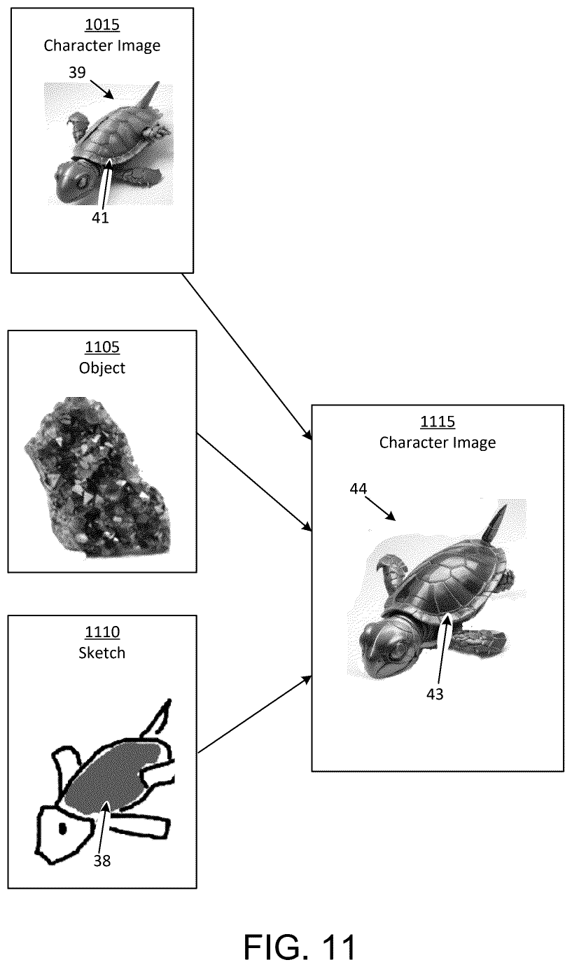

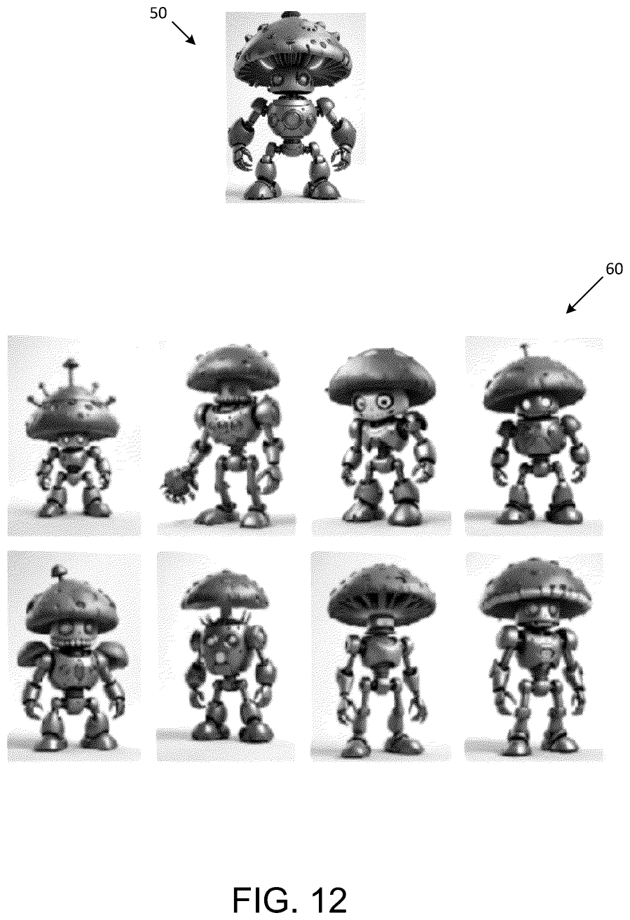

FIG. 11 illustrates a fifth example operational configuration for generating a character image 1115 according to various embodiments. The inputs provided to the image generator 180 include the character image 1015 described above with respect to FIG. 10, an object 1105, and a sketch 1110. In an example scenario, a user may be dissatisfied with a color of the shell 41 of the turtle 39 shown in FIG. 10 and desires a shell of a different color. The user may prefer a color of the object 1105, which, in such an example, is an amethyst. The sketch 1110 includes a mask 38 that provides an indication to the image generator 180 that the shell 41 of the turtle 39 should be modified to reflect the color of the amethyst. A text-based prompt may also be included to provide this indication. The image generator 180 responds to the inputs by generating the character image 1115 of a turtle 44 having a shell 43 that matches the color of the amethyst.

FIG. 12 illustrates a history associated with generating a character image 50. The character image 50 can be included in a character card displayed on the display 155 of the user interface 145 along with various buttons or icons that can be activated by a user for performing various actions. In this case, the user can activate a “history” button to display a historical progression 60 of images that were generated prior to generation of the final version of the character image 50.

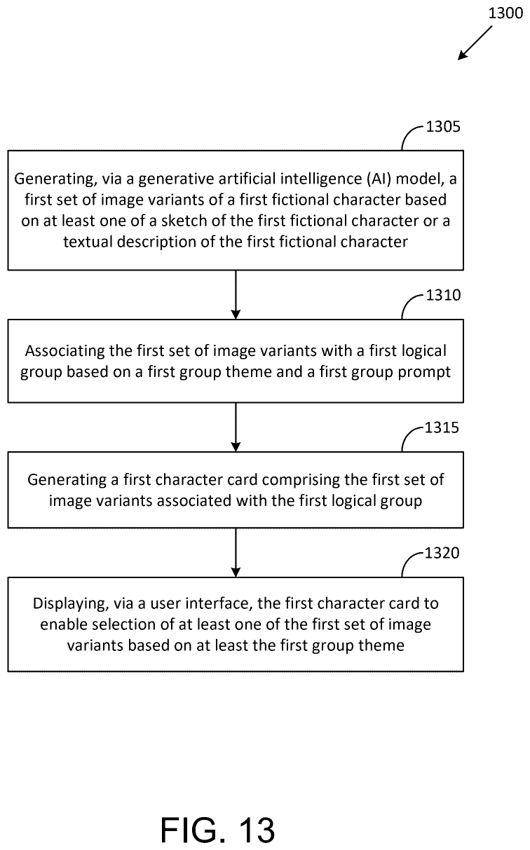

FIG. 13 shows an example flowchart of a method for generating a character card according to various embodiments. At step 1305, a computing platform such as image generation platform 105 described above, generates a first set of image variants of a first fictional character based at least on a sketch of the first fictional character and/or a textual description of the first fictional character. The image variants can be generated by an AI engine, such as AI engine 110, based on executing one or more of various AI models. An example set of image variants is shown in FIG. 7.

At step 1310, the method can include associating the first set of image variants with a first logical group based on a first group theme and a first group prompt. As described above, an example set 610 of “n” character image variants can be assigned to a first logical group.

At step 1315, the method can include generating a first character card comprising the first set of image variants associated with the first logical group. The first character card can include various types of information such as a group character name, individual character names, a group theme, a group prompt, a seed, a text prompt, an image text prompt, and historical image generation information.

At step 1320, the method can include displaying, via a user interface, the first character card to enable selection of at least one of the first set of image variants based on at least the first group theme. In an example implementation, the first character card can be shown on the display 155 of the user interface 145. A user can select one of the image variants for various purposes, e.g., for generating a staging image. An example staging image 625 is shown in FIG. 9.

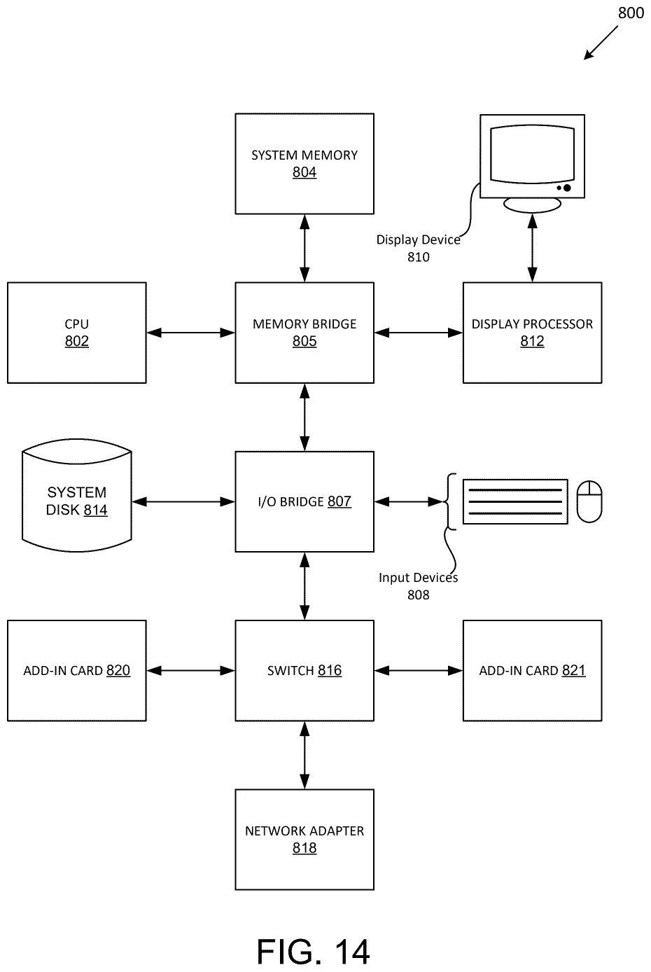

FIG. 14 is an illustration of a computing system 800 that can implement the functionalities of the image generation platform 105 illustrated in FIG. 1, according to various embodiments. This figure in no way limits or is intended to limit the scope of the various embodiments. In various implementations, system 800 may be an augmented reality, virtual reality, or mixed reality system or device, a personal computer, video game console, personal digital assistant, mobile phone, mobile device or any other device suitable for practicing the various embodiments. Further, in various embodiments, any combination of two or more systems 800 may be coupled together to practice one or more aspects of the various embodiments.

As shown, system 800 includes a central processing unit (CPU) 802 and a system memory 804 communicating via a bus path that may include a memory bridge 805. CPU 802 includes one or more processing cores, and, in operation, CPU 802 is the master processor of system 800, controlling and coordinating operations of other system components. System memory 804 stores software applications and data for use by CPU 802. CPU 802 runs software applications and optionally an operating system. Memory bridge 805, which may be, e.g., a Northbridge chip, is connected via a bus or other communication path (e.g., a HyperTransport link) to an I/O (input/output) bridge 807. I/O bridge 807, which may be, e.g., a Southbridge chip, receives user input from one or more user input devices 808 (e.g., keyboard, mouse, joystick, digitizer tablets, touch pads, touch screens, still or video cameras, motion sensors, and/or microphones) and forwards the input to CPU 802 via memory bridge 805.

A display processor 812 is coupled to memory bridge 805 via a bus or other communication path (e.g., a PCI Express, Accelerated Graphics Port, or HyperTransport link); in one embodiment display processor 812 is a graphics subsystem that includes at least one graphics processing unit (GPU) and graphics memory. Graphics memory includes a display memory (e.g., a frame buffer) used for storing pixel data for each pixel of an output image. Graphics memory can be integrated in the same device as the GPU, connected as a separate device with the GPU, and/or implemented within system memory 804.

Display processor 812 periodically delivers pixels to a display device 810 (e.g., a screen or conventional CRT, plasma, OLED, SED or LCD based monitor or television). Additionally, display processor 812 may output pixels to film recorders adapted to reproduce computer generated images on photographic film. Display processor 812 can provide display device 810 with an analog or digital signal. In various embodiments, one or more of the various graphical user interfaces such as, for example, the US illustrated in FIG. 3, are displayed to one or more users via display device 810, and the one or more users can input data into and receive visual output from those various graphical user interfaces.

A system disk 814 is also connected to I/O bridge 807 and may be configured to store content and applications and data for use by CPU 802 and display processor 812. System disk 814 provides non-volatile storage for applications and data and may include fixed or removable hard disk drives, flash memory devices, and CD-ROM, DVD-ROM, Blu-ray, HD-DVD, or other magnetic, optical, or solid-state storage devices.

A switch 816 provides connections between I/O bridge 807 and other components such as a network adapter 818 and various add-in cards 820 and 821. Network adapter 818 allows system 800 to communicate with other systems via an electronic communications network, and may include wired or wireless communication over local area networks and wide area networks such as the Internet.

Other components (not shown), including USB or other port connections, film recording devices, and the like, may also be connected to I/O bridge 807. For example, an audio processor may be used to generate analog or digital audio output from instructions and/or data provided by CPU 802, system memory 804, or system disk 814. Communication paths interconnecting the various components in FIG. 8 may be implemented using any suitable protocols, such as PCI (Peripheral Component Interconnect), PCI Express (PCI-E), AGP (Accelerated Graphics Port), HyperTransport, or any other bus or point-to-point communication protocol(s), and connections between different devices may use different protocols, as is known in the art.

In one embodiment, display processor 812 incorporates circuitry optimized for graphics and video processing, including, for example, video output circuitry, and constitutes a graphics processing unit (GPU). In another embodiment, display processor 812 incorporates circuitry optimized for general purpose processing. In yet another embodiment, display processor 812 may be integrated with one or more other system elements, such as the memory bridge 805, CPU 802, and I/O bridge 807 to form a system on chip (SoC). In still further embodiments, display processor 812 is omitted and software executed by CPU 802 performs the functions of display processor 812.

Pixel data can be provided to display processor 812 directly from CPU 802. In some embodiments, instructions and/or data representing a scene are provided to a render farm or a set of server computers, each similar to system 800, via network adapter 818 or system disk 814. The render farm generates one or more rendered images of the scene using the provided instructions and/or data. These rendered images may be stored on computer-readable media in a digital format and optionally returned to system 800 for display. Similarly, stereo image pairs processed by display processor 812 may be output to other systems for display, stored in system disk 814, or stored on computer-readable media in a digital format.

Alternatively, CPU 802 provides display processor 812 with data and/or instructions defining the desired output images, from which display processor 812 generates the pixel data of one or more output images, including characterizing and/or adjusting the offset between stereo image pairs. The data and/or instructions defining the desired output images can be stored in system memory 804 or graphics memory within display processor 812. In an embodiment, display processor 812 includes 3D rendering capabilities for generating pixel data for output images from instructions and data defining the geometry, lighting shading, texturing, motion, and/or camera parameters for a scene. Display processor 812 can further include one or more programmable execution units capable of executing shader programs, tone mapping programs, and the like.

Further, in other embodiments, CPU 802 or display processor 812 may be replaced with or supplemented by any technically feasible form of processing device configured process data and execute program code. Such a processing device could be, for example, a central processing unit (CPU), a graphics processing unit (GPU), an application-specific integrated circuit (ASIC), a field-programmable gate array (FPGA), and so forth. In various embodiments any of the operations and/or functions described herein can be performed by CPU 802, display processor 812, or one or more other processing devices or any combination of these different processors.

CPU 802, render farm, and/or display processor 812 can employ any surface or volume rendering technique known in the art to create one or more rendered images from the provided data and instructions, including rasterization, scanline rendering REYES or micropolygon rendering, ray casting, ray tracing, image-based rendering techniques, and/or combinations of these and any other rendering or image processing techniques known in the art.

In other contemplated embodiments, system 800 may be a robot or robotic device and may include CPU 802 and/or other processing units or devices and system memory 804. In such embodiments, system 800 may or may not include other elements shown in FIG. 8. System memory 804 and/or other memory units or devices in system 800 may include instructions that, when executed, cause the robot or robotic device represented by system 800 to perform one or more operations, steps, tasks, or the like.

It will be appreciated that the system shown herein is illustrative and that variations and modifications are possible. The connection topology, including the number and arrangement of bridges, may be modified as desired. For instance, in some embodiments, system memory 804 is connected to CPU 802 directly rather than through a bridge, and other devices communicate with system memory 804 via memory bridge 805 and CPU 802. In other alternative topologies display processor 812 is connected to I/O bridge 807 or directly to CPU 802, rather than to memory bridge 805. In still other embodiments, I/O bridge 807 and memory bridge 805 might be integrated into a single chip. The particular components shown herein are optional; for instance, any number of add-in cards or peripheral devices might be supported. In some embodiments, switch 816 is eliminated, and network adapter 818 and add-in cards 820, 821 connect directly to I/O bridge 807.

In sum, the disclosed techniques set forth systems and methods for generating images through the use of an AI engine configured to implement various AI models, including generative AI models. An example procedure involves the AI engine generating various kinds of images in response to one or more types of multimodal inputs, such as a text prompt, a hand-drawn sketch, or a reference image. The generated images can include character images, group images, perspective images, and staging images. Character images can represent, for example, imaginary characters suitable for inclusion in items such as video games or comic strips. A set of images corresponding to a group theme, such as heroes or villains, can be included in a group image. In some embodiments, the AI engine generates a set of image variants based on a character image. The image variants enable a developer to visualize various scenes, such as an underwater battle scene between a female wearing red robot armor and an evil robot wearing a blue mechatronic outfit. In another embodiment, group images can have different perspectives that enable a developer to ensure consistency in appearance regarding characteristics such as height, features, colors, and accessories within various scenes of a video game. In another embodiment, the AI engine can generate a hybrid image that includes various parts selected from different images. In another embodiment, the AI engine can generate a character image by combining a hand-drawn sketch with a portion or a characteristic, such as color or shape, of another image or object.

One technical advantage of the disclosed techniques over the prior art is that the disclosed techniques reduce redundant rendering and data transfer operations, which decreases processing latency and overall memory bandwidth consumption. In addition to reducing latency, the disclosed techniques minimize generation of intermediate files and associated format conversions, thereby lowering I/O overhead and storage utilization during design revisions. The disclosed techniques also improve computational efficiency by coordinating related design inputs within a unified processing framework, which enables reuse of prior computational results across multiple image-generation cycles. Further, network efficiency is improved during collaborative workflows through a reduction in the volume of transmitted image data associated with iterative refinement cycles. Collectively, the disclosed techniques provide a scalable computational environment that enables consistent management of related image variants across diverse design contexts while maintaining efficient use of available processing and storage resources. These technical advantages provide one or more technological advancements over prior art approaches.

1. In some embodiments, a computer-implemented method for generating images comprises: generating, via a generative artificial intelligence (AI) model, a first set of image variants of a first fictional character based at least on one of a sketch of the first fictional character or a textual description of the first fictional character; associating the first set of image variants with a first logical group based on a first group theme and a first group prompt; generating a first character card comprising the first set of image variants associated with the first logical group; and displaying, via a user interface, the first character card to enable selection of at least one of the first set of image variants based on at least the first group theme.

2. The computer-implemented method of clause 1, wherein the first set of image variants comprises a first set of perspective views of the first fictional character, and wherein the first group prompt is a text prompt that is useable for adding additional fictional characters to the first logical group based on conformance to the first group theme.

3. The computer-implemented method of any of clauses 1-2, further comprising: receiving, via the user interface, a name of the first fictional character, a first seed number for use by the generative AI model to execute a diffusion model, the first group prompt, and the at least one of the sketch of the first fictional character or the textual description of the first fictional character; generating, via the generative AI model, a character image of the first fictional character based on the first seed number; and generating, via the generative AI model, the first set of image variants based on the character image.

4. The computer-implemented method of any of clauses 1-3, wherein the first group prompt comprises a textual description of the first group theme, and wherein generating the character image is further based on at least one of the name of the first fictional character or the first group prompt.

5. The computer-implemented method of any of clauses 1-4, further comprising: receiving, via the user interface, a name of a second fictional character, a second seed number for use by the generative AI model to execute the diffusion model, and the at least one of the sketch of the second fictional character or the textual description of the second fictional character; and generating, via the generative AI model, a second set of image variants of the second fictional character based on at least the second seed number.

6. The computer-implemented method of any of clauses 1-5, further comprising: receiving, via the user interface, a name of a second fictional character, and the at least one of the sketch of the second fictional character or the textual description of the second fictional character; generating, via the generative AI model, the second fictional character based on the first seed number; and including the second fictional character to the first logical group.

7. The computer-implemented method of any of clauses 1-6, further comprising: generating, via the generative AI model, a second set of image variants of a second fictional character based on the first group prompt and at least one of a sketch of the second fictional character or a textual description of the second fictional character; generating a staging card comprising a selected one of the first set of image variants and a selected one of the second set of image variants; and displaying, via the user interface, the staging card to enable an evaluation of a visual relationship between the first fictional character and the second fictional character.

8. The computer-implemented method of any of clauses 1-7, further comprising: generating, via the generative AI model, a second set of image variants of a second fictional character based on a second group prompt and at least one of a sketch of the second fictional character or a textual description of the second fictional character; generating a second character card comprising a selected one of the first set of image variants and a selected one of the second set of image variants; and displaying, via the user interface, the second character card to enable evaluation of a visual relationship between the first fictional character and the second fictional character.

9. The computer-implemented method of any of clauses 1-8, further comprising: receiving, via the user interface, a first seed number for use by the generative AI model to execute a diffusion model for generating the first set of image variants of the first fictional character.

10. The computer-implemented method of any of clauses 1-9, further comprising: generating, via the generative AI model, a second set of image variants of a second fictional character based on at least one of a sketch of the second fictional character or a textual description of the second fictional character; generating a second logical group of the second set of image variants; associating the second set of image variants to a second group theme based on a second group prompt; generating a staging card comprising a selected one of the first set of image variants and a selected one of the second set of image variants; and displaying, via the user interface, the staging card to enable an evaluation of an interaction between the first fictional character conforming to the first group theme and the second fictional character conforming to the second group theme.

11. In some embodiments, one or more non-transitory computer readable media store instructions that, when executed by one or more processors, cause the one or more processors to generate images, by carrying out the operations of: generating, via a generative artificial intelligence (AI) model, a first set of image variants of a first fictional character based at least on one of a sketch of the first fictional character or a textual description of the first fictional character; associating the first set of image variants with a first logical group based on a first group theme and a first group prompt; generating a first character card comprising the first set of image variants associated with the first logical group; and displaying, via a user interface, the first character card to enable selection of at least one of the first set of image variants based on at least the first group theme.

12. The one or more non-transitory computer readable media of clause 11, wherein the first set of image variants comprises a first set of perspective views of the first fictional character, and wherein the first group prompt is a text prompt that is useable for adding additional fictional characters to the first logical group based on conformance to the first group theme.

13. The one or more non-transitory computer readable media of any of clauses 11-12, wherein the operations further comprise: receiving, via the user interface, a name of the first fictional character, a first seed number for use by the generative AI model to execute a diffusion model, the first group prompt, and the at least one of the sketch of the first fictional character or the textual description of the first fictional character; generating, via the generative AI model, a character image of the first fictional character based on the first seed number; and generating, via the generative AI model, the first set of image variants based on the character image.

14. The one or more non-transitory computer readable media of any of clauses 11-13, wherein the first group prompt comprises a textual description of the first group theme, and wherein generating the character image is further based on at least one of the name of the first fictional character or the first group prompt.

15. The one or more non-transitory computer readable media of any of clauses 11-14, wherein the operations further comprise: receiving, via the user interface, a name of a second fictional character, a second seed number for use by the generative AI model to execute the diffusion model, and the at least one of the sketch of the second fictional character or the textual description of the second fictional character; and generating, via the generative AI model, a second set of image variants of the second fictional character based on at least the second seed number.

16. The one or more non-transitory computer readable media of any of clauses 11-15, wherein the operations further comprise: receiving, via the user interface, a name of a second fictional character, and the at least one of the sketch of the second fictional character or the textual description of the second fictional character; generating, via the generative AI model, the second fictional character based on the first seed number; and including the second fictional character to the first logical group.

17. The one or more non-transitory computer readable media of any of clauses 11-16, wherein the first fictional character is represented by a hybrid character image that is generated by combining a first portion of a first character image with a second portion of a second character image.

18. The one or more non-transitory computer readable media of any of clauses 11-17, wherein the hybrid character image is generated based on at least a textual description of a hybrid character, a first reference image, and a second reference image, wherein the first reference image comprises a first bounding box indicating a location of the first portion of the first character image, and wherein the second reference image comprises a second bounding box indicating a location of the second portion of the second character image.

19. The one or more non-transitory computer readable media of any of clauses 11-18, wherein the first bounding box is indicated by a first color and the second bounding box is indicated by a second color.

20. In some embodiments, a computer system comprises one or more memories that include instructions, and one or more processors that are coupled to the one or more memories and that, when executing the instructions, are configured to perform the operations of: generating, via a generative artificial intelligence (AI) model, a first set of image variants of a first fictional character based at least on one of a sketch of the first fictional character or a textual description of the first fictional character; associating the first set of image variants with a first logical group based on a first group theme and a first group prompt; generating a first character card comprising the first set of image variants associated with the first logical group, and displaying, via a user interface, the first character card to enable selection of at least one of the first set of image variants based on at least the first group theme.

Any and all combinations of any of the claim elements recited in any of the claims and/or any elements described in this application, in any fashion, fall within the contemplated scope of the present disclosure and protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module,” a “system,” or a “computer.” In addition, any hardware and/or software technique, process, function, component, engine, module, or system described in the present disclosure may be implemented as a circuit or set of circuits. Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general-purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The invention has been described above with reference to specific embodiments. Persons of ordinary skill in the art, however, will understand that various modifications and changes may be made thereto without departing from the broader spirit and scope of the invention as set forth in the appended claims. For example, and without limitation, although many of the descriptions herein refer to specific types of I/O devices that may acquire data associated with an object of interest, persons skilled in the art will appreciate that the systems and techniques described herein are applicable to other types of I/O devices. The foregoing description and drawings are, accordingly, to be regarded in an illustrative rather than a restrictive sense.

While the preceding is directed to embodiments of the present disclosure, other and further embodiments of the disclosure may be devised without departing from the basic scope thereof, and the scope thereof is determined by the claims that follow.

What is claimed is:

1. A computer-implemented method for generating images, the method comprising:
generating, via a generative artificial intelligence (AI) model, a first set of image variants of a first fictional character based at least on one of a sketch of the first fictional character or a textual description of the first fictional character;
associating the first set of image variants with a first logical group based on a first group theme and a first group prompt;
generating a first character card comprising the first set of image variants associated with the first logical group; and
displaying, via a user interface, the first character card to enable selection of at least one of the first set of image variants based on at least the first group theme.

2. The computer-implemented method of claim 1, wherein the first set of image variants comprises a first set of perspective views of the first fictional character, and wherein the first group prompt is a text prompt that is useable for adding additional fictional characters to the first logical group based on conformance to the first group theme.

3. The computer-implemented method of claim 1, further comprising:
receiving, via the user interface, a name of the first fictional character, a first seed number for use by the generative AI model to execute a diffusion model, the first group prompt, and the at least one of the sketch of the first fictional character or the textual description of the first fictional character;
generating, via the generative AI model, a character image of the first fictional character based on the first seed number; and
generating, via the generative AI model, the first set of image variants based on the character image.

4. The computer-implemented method of claim 3, wherein the first group prompt comprises a textual description of the first group theme, and wherein generating the character image is further based on at least one of the name of the first fictional character or the first group prompt.

5. The computer-implemented method of claim 3, further comprising:
receiving, via the user interface, a name of a second fictional character, a second seed number for use by the generative AI model to execute the diffusion model, and the at least one of the sketch of the second fictional character or the textual description of the second fictional character; and
generating, via the generative AI model, a second set of image variants of the second fictional character based on at least the second seed number.

6. The computer-implemented method of claim 3, further comprising:
receiving, via the user interface, a name of a second fictional character, and the at least one of the sketch of the second fictional character or the textual description of the second fictional character;
generating, via the generative AI model, the second fictional character based on the first seed number; and
including the second fictional character to the first logical group.

7. The computer-implemented method of claim 1, further comprising:
generating, via the generative AI model, a second set of image variants of a second fictional character based on the first group prompt and at least one of a sketch of the second fictional character or a textual description of the second fictional character;
generating a staging card comprising a selected one of the first set of image variants and a selected one of the second set of image variants; and
displaying, via the user interface, the staging card to enable an evaluation of a visual relationship between the first fictional character and the second fictional character.

8. The computer-implemented method of claim 1, further comprising:
generating, via the generative AI model, a second set of image variants of a second fictional character based on a second group prompt and at least one of a sketch of the second fictional character or a textual description of the second fictional character;
generating a second character card comprising a selected one of the first set of image variants and a selected one of the second set of image variants; and
displaying, via the user interface, the second character card to enable evaluation of a visual relationship between the first fictional character and the second fictional character.

9. The computer-implemented method of claim 1, further comprising:
receiving, via the user interface, a first seed number for use by the generative AI model to execute a diffusion model for generating the first set of image variants of the first fictional character.

10. The computer-implemented method of claim 1, further comprising:
generating, via the generative AI model, a second set of image variants of a second fictional character based on at least one of a sketch of the second fictional character or a textual description of the second fictional character;
generating a second logical group of the second set of image variants;
associating the second set of image variants to a second group theme based on a second group prompt;
generating a staging card comprising a selected one of the first set of image variants and a selected one of the second set of image variants; and
displaying, via the user interface, the staging card to enable an evaluation of an interaction between the first fictional character conforming to the first group theme and the second fictional character conforming to the second group theme.

11. One or more non-transitory computer readable media storing instructions that, when executed by one or more processors, cause the one or more processors to generate images, the operations comprising:
generating, via a generative artificial intelligence (AI) model, a first set of image variants of a first fictional character based at least on one of a sketch of the first fictional character or a textual description of the first fictional character;
associating the first set of image variants with a first logical group based on a first group theme and a first group prompt;
generating a first character card comprising the first set of image variants associated with the first logical group; and
displaying, via a user interface, the first character card to enable selection of at least one of the first set of image variants based on at least the first group theme.

12. The one or more non-transitory computer readable media of claim 11, wherein the first set of image variants comprises a first set of perspective views of the first fictional character, and wherein the first group prompt is a text prompt that is useable for adding additional fictional characters to the first logical group based on conformance to the first group theme.

13. The one or more non-transitory computer readable media of claim 11, wherein the operations further comprise:
receiving, via the user interface, a name of the first fictional character, a first seed number for use by the generative AI model to execute a diffusion model, the first group prompt, and the at least one of the sketch of the first fictional character or the textual description of the first fictional character;
generating, via the generative AI model, a character image of the first fictional character based on the first seed number; and
generating, via the generative AI model, the first set of image variants based on the character image.

14. The one or more non-transitory computer readable media of claim 13, wherein the first group prompt comprises a textual description of the first group theme, and wherein generating the character image is further based on at least one of the name of the first fictional character or the first group prompt.

15. The one or more non-transitory computer readable media of claim 13, wherein the operations further comprise:
receiving, via the user interface, a name of a second fictional character, a second seed number for use by the generative AI model to execute the diffusion model, and the at least one of the sketch of the second fictional character or the textual description of the second fictional character; and
generating, via the generative AI model, a second set of image variants of the second fictional character based on at least the second seed number.

16. The one or more non-transitory computer readable media of claim 13, wherein the operations further comprise:
receiving, via the user interface, a name of a second fictional character, and the at least one of the sketch of the second fictional character or the textual description of the second fictional character;
generating, via the generative AI model, the second fictional character based on the first seed number; and
including the second fictional character to the first logical group.

17. The one or more non-transitory computer readable media of claim 11, wherein the first fictional character is represented by a hybrid character image that is generated by combining a first portion of a first character image with a second portion of a second character image.

18. The one or more non-transitory computer readable media of claim 17, wherein the hybrid character image is generated based on at least a textual description of a hybrid character, a first reference image, and a second reference image, wherein the first reference image comprises a first bounding box indicating a location of the first portion of the first character image, and wherein the second reference image comprises a second bounding box indicating a location of the second portion of the second character image.

19. The one or more non-transitory computer readable media of claim 18, wherein the first bounding box is indicated by a first color and the second bounding box is indicated by a second color.

20. A computer system, comprising:
one or more memories that include instructions; and
one or more processors that are coupled to the one or more memories and, when executing the instructions, are configured to perform the operations of:
generating, via a generative artificial intelligence (AI) model, a first set of image variants of a first fictional character based at least on one of a sketch of the first fictional character or a textual description of the first fictional character;
associating the first set of image variants with a first logical group based on a first group theme and a first group prompt;
generating a first character card comprising the first set of image variants associated with the first logical group; and
displaying, via a user interface, the first character card to enable selection of at least one of the first set of image variants based on at least the first group theme.
